(19) United States
(12) Patent Application Publication
(10) Pub. No.: US 2024/0005666 A1
(43) Pub. Date: Jan. 4, 2024

(54) MANAGING VEHICLE RESOURCES BASED ON SCENARIOS

(71) Applicant: Motional AD LLC, Boston, MA (US)

(72) Inventor: Ting Wang, Rancho Palos Verdes, CA (US)

(21) Appl. No.: 18/139,895

(22) Filed: Apr. 26, 2023

Related U.S. Application Data
(60) Provisional application No. 63/363,599, filed on Apr. 26, 2022.

(51) Int. Cl. G06V 20/56; B60W 60/00

(52) U.S. Cl. CPC G06V 20/56; B60W 60/001; B60W 2420/52; B60W 2420/42

(57) ABSTRACT

Provided are methods for managing vehicle resources based on scenarios, which can include obtaining, from the at least one sensor, information representative of the environment of the vehicle; determining, based on the information representative of the environment of the vehicle, a current scenario of the environment of the vehicle; determining, based on the determined current scenario, a level of computational resources appropriate for the determined current scenario; and adjusting at least one parameter associated with the at least one sensor based on the determined level of computational resources. Systems and computer program products are also provided.

### CROSS-REFERENCE TO RELATED APPLICATIONS

The present application claims priority to U.S. Provisional Patent Appl. No. 63/363,599, filed Apr. 26, 2022, and incorporates herein by reference in their entireties the disclosure of the U.S. Non-Provisional patent application Ser. No. 18/139,526, titled “SCALABLE CONFIGURABLE CHIP ARCHITECTURE” filed on Apr. 26, 2023 and the U.S. Non-Provisional patent application Ser. No. 18/139,857, titled “DISTRIBUTED COMPUTING ARCHITECTURE WITH SHARED MEMORY FOR AUTONOMOUS ROBOTIC SYSTEMS” filed on Apr. 26, 2023.

### BACKGROUND

Autonomous vehicles incorporate computer processors and sensors in order to navigate on roads and other drivable areas. The conditions encountered by an autonomous vehicle can vary. Different types of conditions necessitate different types of actions by the vehicle.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 4E is a diagram of an implementation of a machine learning model;

FIG. 5 is a diagram of an implementation of a process for managing vehicle resources based on scenarios; and

FIG. 6 is a flowchart of a process for managing vehicle resources based on scenarios; and

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

A vehicle (such as an autonomous vehicle) can adapt its use of computational resources to a scenario encountered by the vehicle. A scenario is a category of conditions in the vehicle's environment, e.g., the activity occurring in the vehicle's environment. Different scenarios necessitate different amounts of vehicle resources when the vehicle is operating in the respective scenario. For example, a scenario that includes a large amount of pedestrian traffic may demand more computational resources (including battery power and communications network bandwidth) because navigation in proximity to pedestrians requires more complex computations and more information gathered and processed from the vehicle's sensors. Thus, the vehicle can increase the resources available in more demanding scenarios and reduce the resources available in less demanding scenarios.

Some of the advantages of these techniques include better power management without loss of vehicle function. Because fewer computational resources are used in less demanding scenarios, the vehicle can save on power consumption and communications network bandwidth.

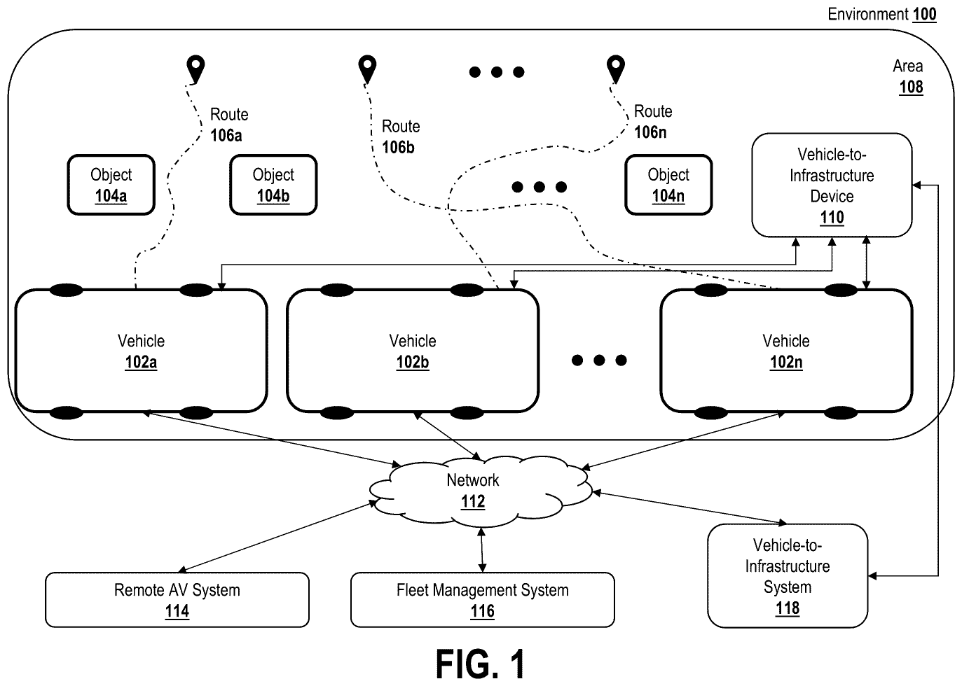

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

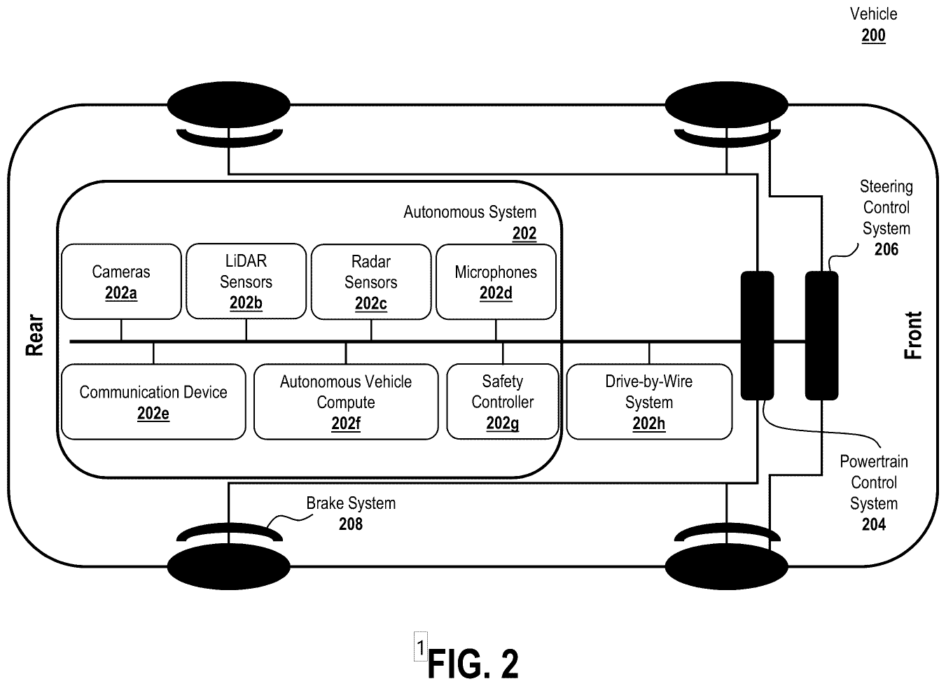

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like.

In one embodiment, autonomous system 202 includes operation or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

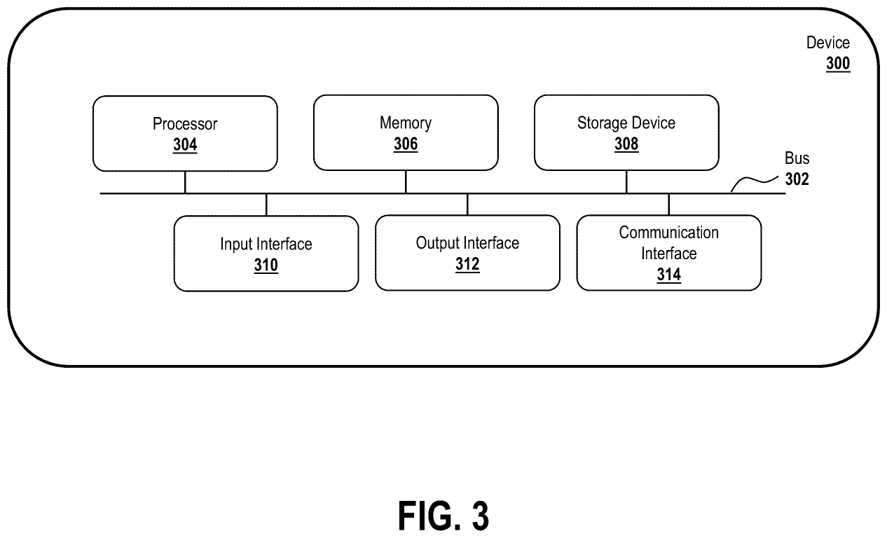

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charged-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is configured to implement autonomous vehicle software 400, described herein. In an embodiment, autonomous vehicle compute 202 f is the same or similar to distributed computing architecture. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

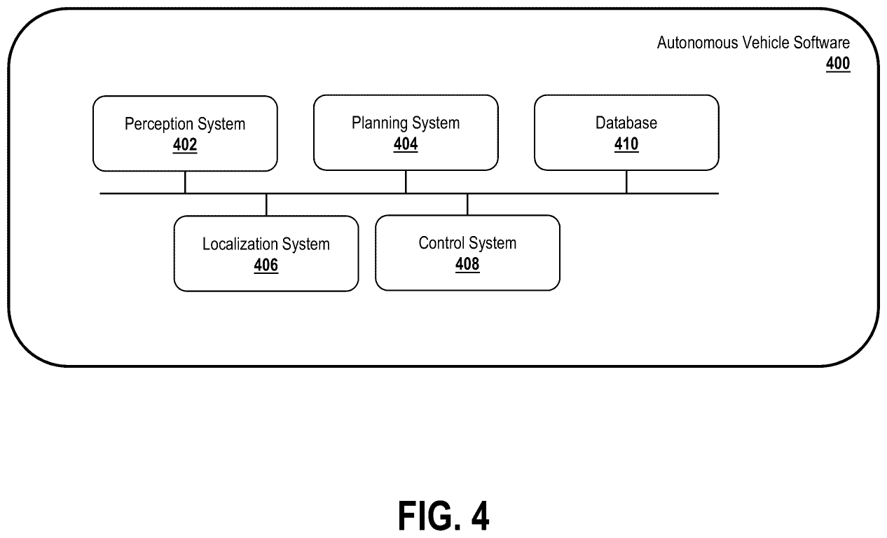

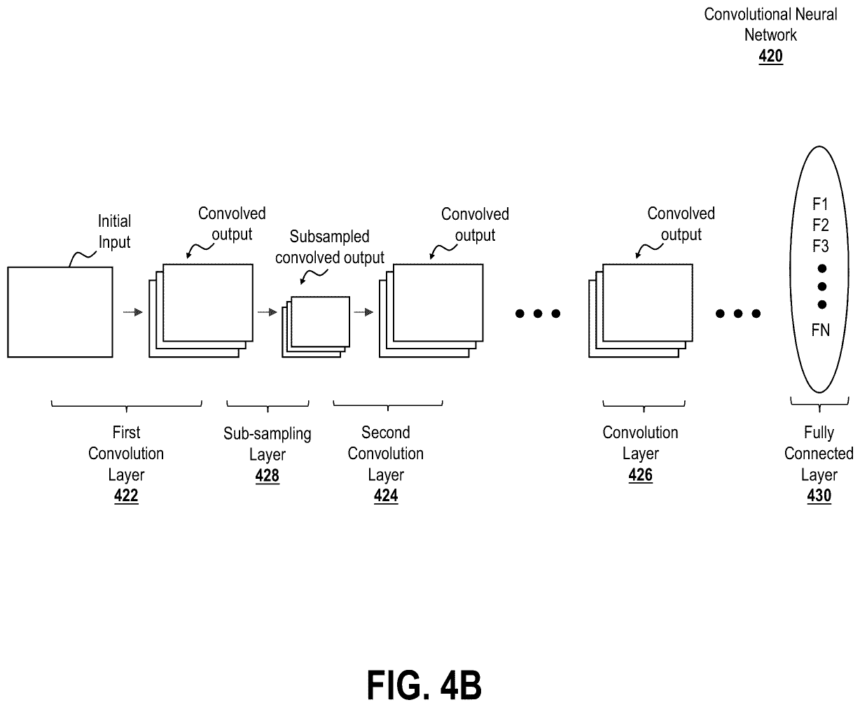

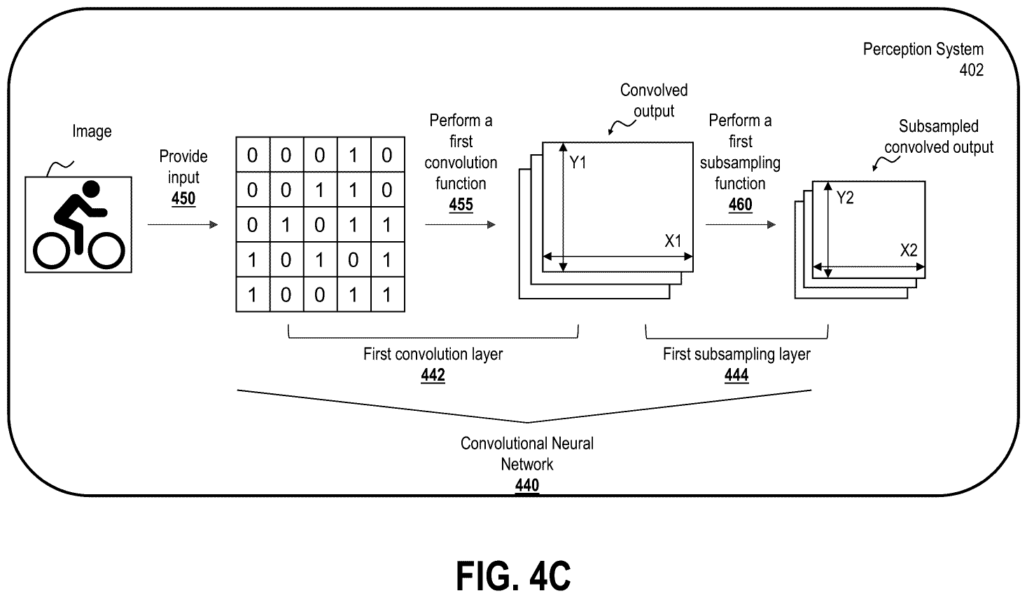

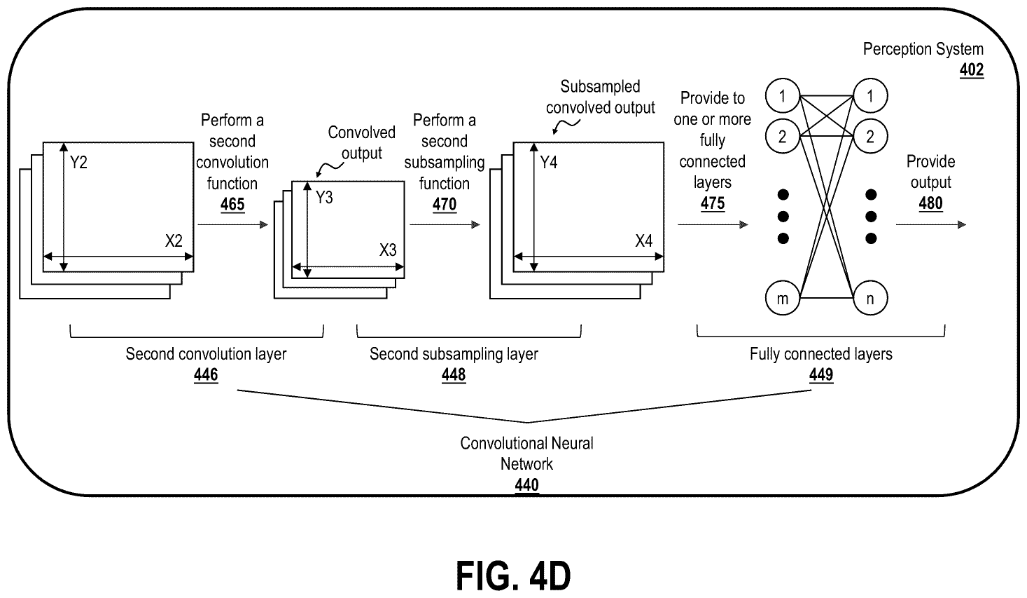

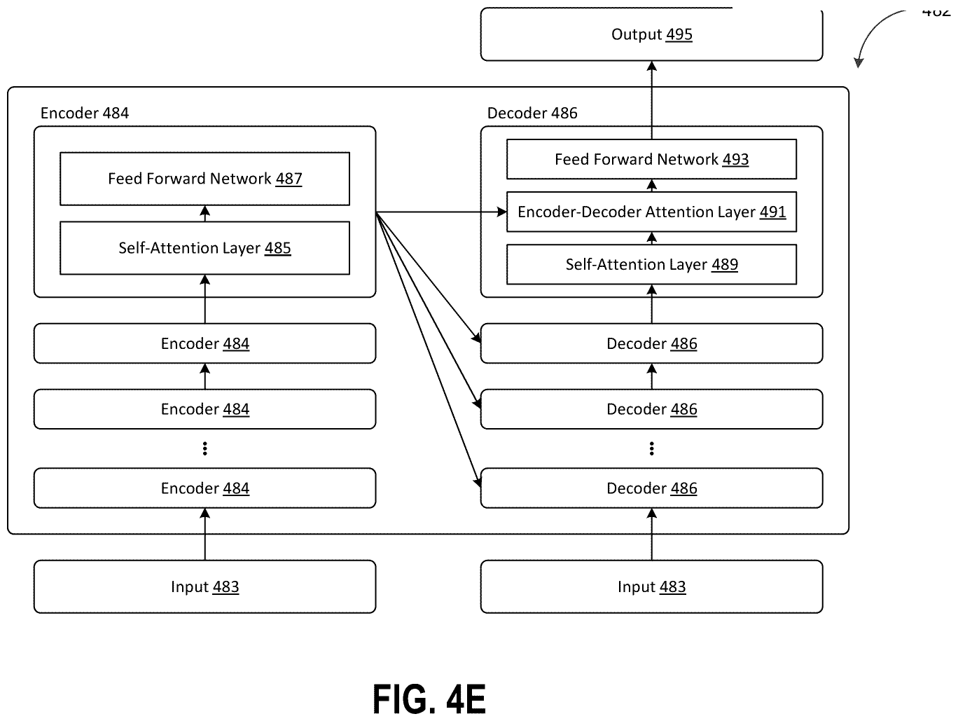

Referring now to FIG. 4, illustrated is an example block diagram of an autonomous vehicle software 400 (sometimes referred to as an “AV stack”). As illustrated, autonomous vehicle software 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle software 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle software 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle software 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle software 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 402 normalizing sensor data (e.g., image data, LiDAR data, radar data, and/or the like).

In some embodiments, CNN 420 generates an output based on perception system 402 performing convolution operations associated with each convolution layer. In some examples, CNN 420 generates an output based on perception system 402 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 430 includes data associated with a plurality of feature values referred to as F1, F2 . . . FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, . . . FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

Referring now to FIG. 4E, illustrated is a diagram of an implementation of a machine learning model. More specifically, illustrated is a diagram of an implementation of a transformer model 482. In some example embodiments, the transformer model 482 may implement the perception system 402, the planning system 404, the localization system 406, and/or control system 408. As will be described in more detail, the transformer model 482 may include a self-attention mechanism to capture the relative significance and relationship between different portions of an input 483. For instance, in cases where the input 483 is an image (e.g., of the environment proximate to a vehicle), the self-attention mechanism of the transformer model 482 may capture the relative significance and relationship amongst different portions (or patches) of the image when generating an output 495 that includes, for example, one or more labels classifying one or more objects present in the image. While the transformer model 482 includes certain features as described herein, these features are provided for the purpose of illustration and are not intended to limit the present disclosure.

As shown in FIG. 4E, the transformer model 482 may include an encoder stack having a plurality of encoders 484 (or encoding layers) coupled with a decoder stack having a plurality of decoders 486 (or decoding layers). In the example shown in FIG. 4E, the input 483 (e.g., the embedding of each individual portion of the input 483) flows through successive encoders 484, with the output of the final encoder 484 being passed to every decoder 486 in the decoder stack. For example, in some cases, each encoder 484 in the encoder stack may generate an encoding that contains information about which parts of the input 483 are relevant to each other. Moreover, the output of one encoder 484 may be passed on as an input to the next encoder 484 in the encoder stack. Accordingly, in some cases, the first encoder 484 in the encoder stack may generate a first encoding of the input 483 (e.g., the embedding of each individual portion of the input 483) while the next encoder 484 in the encoder stack may generate a second encoding of the first encoding.

As shown in FIG. 4E, in some cases, each encoder 484 may include self-attention layer 485 and a feed-forward network 487. Each portion of the input 483 (e.g., each embedded portion of the input 483) may flow through its own path in the encoder 484, with the self-attention layer 485 determining the relationship (or association) between each individual portion of the input 483. For example, in cases where the input 483 is an image, the self-attention layer 485 may determine the relationship between different portions (or patches) of the image. In doing so, the self-attention layer 485 enables the encoder 484 to generate a context-aware encoding of the input 483 where the encoding for each individual portion of the input 483 incorporates weighted values corresponding to the other portions of the input 483. For instance, in some cases, the encoding for a first portion of the input 483 (e.g., a first embedding of the first portion of the input 483) may be generated to incorporate a first value corresponding to a second portion of the input 483 and a second value corresponding to a third portion of the input 483, with the first value and the second value being weighted to reflect how much the second portion and the third portion of the input 483 should affect the encoding for the first portion of the input 483. In some cases, the self-attention layer 485 may include a multi-headed attention mechanism, with each head applying a different set of weights (e.g., query, key, and value weight matrices) for incorporating the other portions of the input 483. It should be appreciated that the weights (e.g., query, key, and value weight matrices) applied by the self-attention layer 485 may be learned during the training of the transformer model 482.

Referring again to FIG. 4E, the decoder stack may decode the input 483 to generate the output 495 based on attention vectors output by the final encoder 484 in the encoder stack, with each decoder 486 in the decoder stack successively decoding the output of the previous decoder 486. For example, the first decoder 486 in the decoder stack may generate a first decoding of the input 483 (e.g., the embedding of each individual portion of the input 483) while the next decoder 486 in the decoder stack may generate a second decoding of the first decoding. As shown in FIG. 4E, each decoder 486 may include a self-attention layer 489, an encoder-decoder attention layer 491, and a feed forward network 493. The self-attention layer 489 of the decoder 486 may enable the decoder 486 to generate a context-aware decoding of the input 483 where the decoding for each individual portion of the input 483 incorporates weighted values corresponding to one or more preceding portions of the input 483. Meanwhile, the encoder-decoder attention layer 491 may determine, based at least on the attention vectors output by the final encoder 484 of the encoder stack, weighted values indicative of the relative significance of each corresponding portion of the input 483.

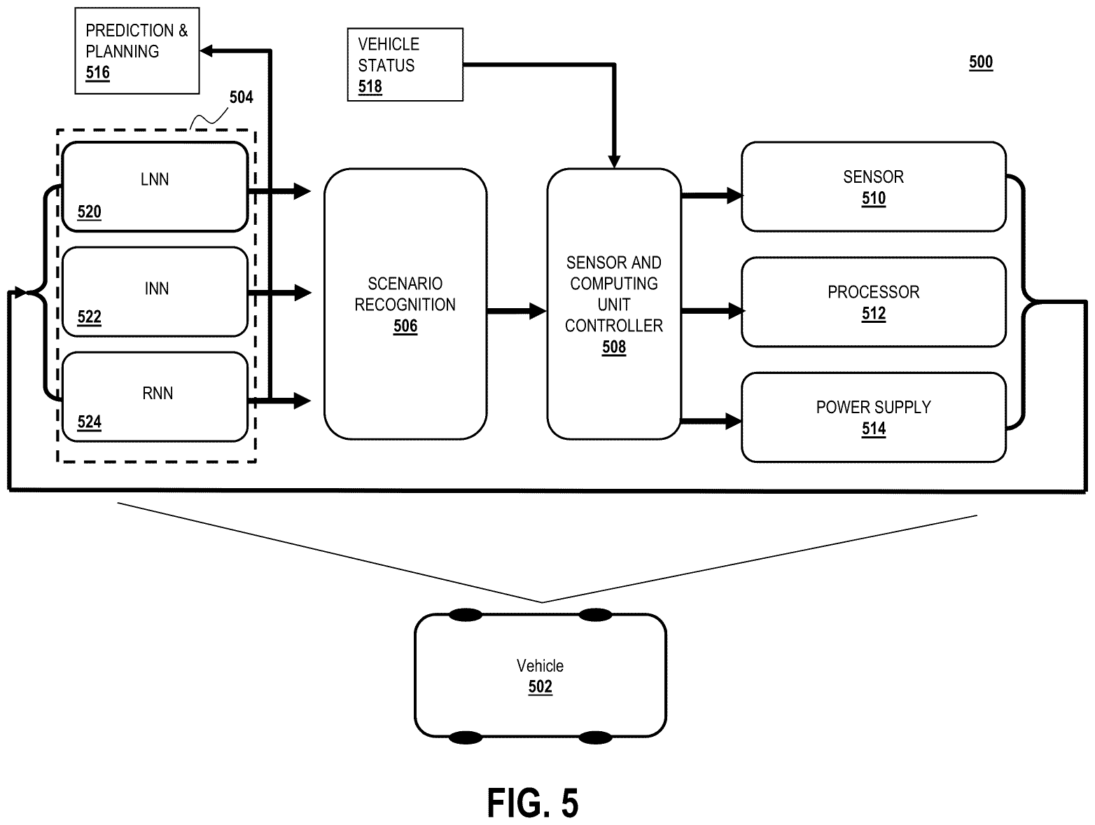

FIG. 5, illustrates a diagram of an example system 500 for managing vehicle resources based on scenarios, by which techniques of the present disclosure can be implemented. As shown in FIG. 5, the example system 500 includes a vehicle 502, a machine learning (ML) detection model 504, a scenario recognition system 506, a sensor and computing unit control 508, a sensor 510, a processor 512, a power supply 514, a prediction and planning component 516, and a vehicle status component 518. The example system 500 can also incorporate other components associated with operation of the vehicle 502 (as described with reference to FIGS. 1-4). The vehicle 502 includes an autonomous vehicle, such as vehicle 200 described with reference to FIG. 2. The vehicle 502 can be configured to include or to be coupled to any of the machine learning (ML) detection model 504, the scenario recognition system 506, the sensor and computing unit control 508, the sensor 510, the processor 512, the power supply 514, the prediction and planning component 516, and the vehicle status component 518. The vehicle 502 can be configured to execute one or more operations for managing vehicle resources based on scenarios predicted by the ML detection model 504.

As illustrated in FIG. 5, the ML detection model 504 can include one or more devices communicatively coupled with vehicle 502. The ML detection model 504 can include a device (or one or more components of a device) that is the same as, or similar to, the perception system 402 of FIG. 4D. In some embodiments, one or more of the functions described herein as associated with the ML detection model 504 can be implemented by, or in coordination with, one or more other devices. The functions of ML detection model 504 can include identification of potential scenarios of the vehicle 502 based on data received from the sensor 510, the processor 512, and/or the power supply 514. The ML detection model 504 can include one or more neural networks (as described in detail with respect to FIGS. 4B-4E), such as a logical neural network (LNN) 520, an invertible neural network (INN) 522, and/or a recurrent neural network (RNN) 524. The neural networks 520, 522, 524 of the ML detection model 504 can be trained on different types of sensor data to predict vehicle operation scenarios. The ML detection model 504 can provide as input data received from the vehicle's sensors 510 to one or more machine learning models 522, 524, 526 trained on scenario data. Output of the machine learning models identifies a particular scenario. In some embodiments, output of the neural networks 520, 522, 524 of the ML detection model 504 and the output of the prediction and planning component 516 can be used in scenario recognition performed by the scenario recognition system 506. The prediction and planning component 516 can include one or more processors configured to predict the future operations of the vehicle 502, given the respective past operations associated with vehicle maneuvers. In some embodiments, the prediction and planning component 516 can include an ML prediction model that can model the energy consumption of different vehicle components when making predictions.

In some embodiments, the scenario recognition system 506 can include one or more devices communicatively coupled with the vehicle 502, the ML detection model 504, the prediction and planning component 516, and the sensor and computing unit control 508. For example, the scenario recognition system 506 can be configured to process the input received from the ML detection model 504 and the prediction and planning component 516 to identify scenarios encountered by the vehicle 502. A scenario can include a category of conditions in the vehicle's environment, e.g., the activity occurring in the vehicle's environment. The scenario recognition system 506 can use information about the vehicle's environment to identify one of several discrete types of scenarios corresponding to the current scenarios. The scenario recognition system 506 can generate a computational resource allocation plan that includes an allocation of an amount of computational resources appropriate to the identified scenario. Examples of computational resources include resources associated with the sensor 510, the processor 512, the power supply 514 (e.g., battery resources), and communication resources (e.g., network resources). The scenario recognition system 506 can transmit the computational resource allocation plan to the sensor and computing unit control 508.

The sensor and computing unit control 508 can include one or more devices communicatively coupled with the vehicle 502, the scenario recognition system 506, the sensor 510, the processor 512, and the power supply 514. For example, the sensor and computing unit control 508 can receive input from the prediction and planning component 516, and the vehicle status component 518 to generate an adjustment of one or more sensor parameters. In some embodiments, the sensor and computing unit control 508 can adjust one or more entries of the computational resource allocation plan according to set criteria and/or set ranges included in a lookup table.

The sensor(s) 510 (e.g., cameras 202a, LiDAR sensors 202b, radar sensors 202c, microphones 202d, communication device 202e, safety controller 202g, and/or DBW system 202h described with reference to FIG. 2) can be configured to monitor various parameters associated with the vehicle 502. For example, some sensor(s) 510 can monitor and/or detect changes occurring in the vehicle's environment, while other sensor(s) 510 can monitor and/or detect various aspects associated with operational aspects of the vehicle 502. Any information and/or data transmitted by the sensor(s) 510 to the ML detection model 504 (or any other processing component) can be used to predict vehicle operation scenarios including a path of travel, direction, speed, and/other movement and/or resource consumption parameters. Such information and/or data includes information and/or data about one or more other agents (e.g., vehicles, pedestrians, objects, etc.) in the vehicle's environment and/or information and/or data about one or more components of the vehicle 502 including the processor 512 and/or the power supply 514. The operations of the vehicle 502 include an adjustment of vehicle resources associated with the movement of the vehicle 502 and/or maneuver parameters executed by the vehicle 502.

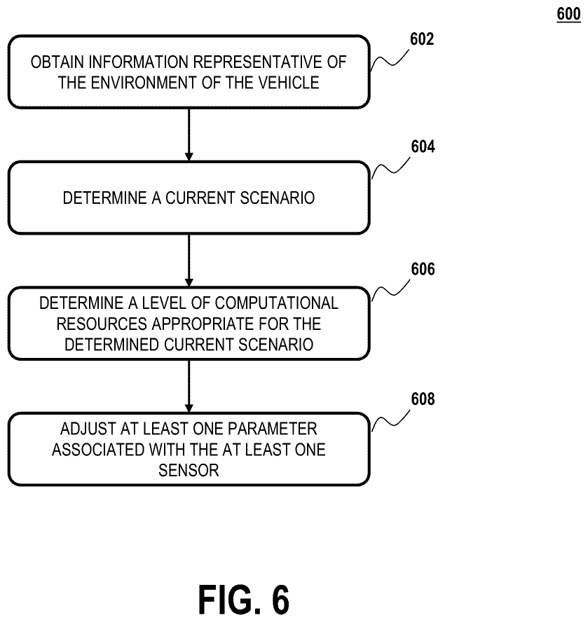

The processor 512 can include one or more processors (e.g., a central processing unit (CPU), a graphics processing unit (GPU), an accelerated processing unit (APU), and/or the like), such as the processor 304 described with reference to FIG. 3. The processor 512 can execute processes according to identified scenarios, as described with reference to FIG. 6. One or more components (e.g., the sensor(s) 510, the processor 512, a motor, a steering control system or other vehicle components described with reference to FIGS. 1-4) of the vehicle 502 can perform processes based on processor 512 executing software instructions according to identified (ongoing or future predicted) scenario.

The power supply 514 can include one or more power supply sources (e.g., rechargeable battery) to provide energy (e.g., fuel, electricity, and/or the like) to one or more components (e.g., the sensor(s) 510, the processor 512, a motor, a steering control system or other vehicle components described with reference to FIGS. 1-4) of the vehicle 502. The power supply 514 can be configured to provide at least sufficient power for minimal energy consumption. The power supply 514 can adjust a supplied power level relative to an identified (ongoing or future predicted) scenario.

In some embodiments, one or more components of the of the example system 500 (e.g., any of the ML detection model 504, the scenario recognition system 506, the sensor and computing unit control 508, the sensor 510, the processor 512, the power supply 514, the prediction and planning component 516, and the vehicle status component 518) can be embodied in an integrated circuit (e.g., a “system on a chip” [SoC]) with functionality specific to the integrated components. A system-on-chip (SoC) refers to an integrated circuit (or a “chip”) that integrates all or most components of a computing system and/or other electronic systems. Such components include, for example, a central processing unit (CPU), input/output (I/O) devices, memory, storage, etc. Other components may include various communication components, graphics processing units (GPU), etc. These components may be integrated on a single substrate or microchip. Various digital, analog, mixed-signal, and/or radio frequency (RF) signal processing functions, etc. may be incorporated as well. A SoC can integrate a microcontroller, a microprocessor and/or one or more processor cores with a GPU, Wi-Fi and/or cellular network radio components, etc. Similar to how a microcontroller integrates a microprocessor with peripheral circuits and memory, a SoC can be seen as integrating a microcontroller with even more advanced peripherals. In some embodiments, the SoC can be a single integrated circuit package that includes a hardware component corresponding to the scenario recognition system 506 (e.g., an application-specific integrated circuit), a hardware component corresponding to the sensor and computing unit controller 508 (e.g., an integrated flash memory component), and one or more hardware components corresponding to the machine learning models 520, 522, 524. In some embodiments, the SoC includes multiple SoCs in communication with each other. For example, the scenario recognition system 506 can be integrated in one SoC, and the processor 512 can be integrated in another SoC. In some embodiments, a SoC includes multiple hardware components, such that at least one hardware component is configured for obtaining information representative of the environment of the vehicle; at least one hardware component including the scenario recognition system 506; at least one hardware component including the sensor and computing unit controller 508; and at least one hardware component configured for adjusting one or more sensor parameters of the sensor 510.

With continued reference to FIG. 5, one or more functions will be described as being performed by the example system 500. The number and arrangement of the components and/or devices of the example system 500, shown in FIG. 5 are provided as an example. There may be additional systems and/or devices, fewer systems and/or devices, different systems and/or device, or differently arrangement systems and/or devices than those shown in FIG. 5. Furthermore, two or more systems and/or devices show in FIG. 5 may be implemented within a single system or a single device, or a single system or a single device shown in FIG. 5 may be implemented as multiple, distributed systems or devices. Additionally, or alternatively, a set of systems or a set of devices (e.g., one or more systems, one or more devices) of the example system 500 may perform one or more functions corresponding to different types of scenarios, described as being performed by another set of systems or another set of devices of the example system 500. The examples of scenario types include “high-traffic scenario,” “crowded pedestrian scenario,” “highway scenario”, “local road scenario”, “parking lot scenario” or other scenarios that can be encountered by the vehicle 502. In some embodiments, different scenarios necessitate different amounts of vehicle resources when the vehicle is operating in the respective scenario. For example, a scenario that includes a large amount of pedestrian traffic may demand more computational resources (including battery power and communications network bandwidth) because navigation in proximity to pedestrians requires more complex computations and more information gathered and processed from the vehicle's sensors.

The scenario recognition system 506 can be used to allocate an amount of computational resources appropriate to the scenario. Examples of computational resources include processor resources, sensor resources, network resources, and battery resources. For example, a “crowded pedestrian scenario” may necessitate the use of a larger amount of computational resources in order to accurately perceive a large number of pedestrians and safely navigate around those pedestrians. In such a scenario, the vehicle 502 may operate its sensors 510 in a way that gathers the most amount of data per unit time. Examples of such sensor operation include operating a camera (e.g., the cameras 202a shown in FIG. 2) at a high frame rate and operating a LIDAR sensor 510 (e.g., LiDAR sensors 202b shown in FIG. 2) at a high rotational frequency (e.g., number of 360 degree rotations around an axis within a set time interval, such as during 1 second). Further, in such a scenario, the vehicle 502 may operate one or more of its processors 512 (e.g., the autonomous vehicle compute 202f shown in FIG. 2) at a high clock speed.

In contrast, some scenarios do not necessitate the use of as many computational resources. For example, a “parking lot scenario” can use fewer computational resources than the “crowded pedestrian scenario” described above. In the “parking lot scenario”, the vehicle 502 can navigate safely in a parking lot (e.g., an empty parking lot) using less information gathered and processed from the surrounding environment. In the “parking lot scenario,” the camera can be set to a lower frame rate (e.g., 30 FPS instead of 60 FPS), the LIDAR sensor can be set to a lower rotational frequency (e.g., 20 Hz instead of 60 Hz), and one or more of the vehicle's processors can be set to a lower clock speed (e.g., 1 GHz instead of 2 GHz). The settings of the “parking lot scenario”, use less power and can extend the battery life of the vehicle's systems. Because less data is being gathered and processed, less bandwidth is used by the vehicle's communications networks (e.g., the bus 302 shown in FIG. 3).

In use, information from one or more of the vehicle's sensors 510 can be provided to one or more machine learning models 520, 522, 524 trained on scenario data. Output of the ML models identifies a particular scenario. In some embodiments, output of the machine learning models 520, 522, 524 can be used by the vehicle prediction & planning component 516 (e.g., the perception system 402 and planning system 404 shown in FIG. 4).

The scenario recognition system 506 can process the identified scenario to determine an appropriate level of computational resources that can be adjusted by the sensor and computing unit controller 508 using a look-up table. In some implementations, techniques other than a look-up table are used (e.g., a machine learning model could be used in place of the look-up table). In some embodiments, the appropriate level of computational resources corresponds to a threshold level of resources. For example, the look-up table can include multiple thresholds, such that each threshold corresponding to one or more scenarios. In such embodiments, the scenarios are arranged in order from least demanding of computational resources to most demanding of computational resources, and each threshold corresponds to a set of configuration parameters.

In some embodiments, the look-up table also has multiple options for levels of computational resources to be used for a particular scenario. For example, the levels of computational resources can vary depending on vehicle status 518 e.g., fully operational in movement, partly operational in stationary state, or operational in energy conservation mode with reduced battery life detected). As an example, if the vehicle status indicates that the vehicle 502 is traveling at a high speed, more computational resources may be needed for a particular scenario than if the vehicle 502 is traveling at a lower speed. The look-up table includes levels of resources appropriate for a high speed (e.g., above a speed threshold) and levels of resources appropriate for a low speed. Other types of vehicle status (e.g., vehicle temperature) may necessitate different levels of resources for similar scenarios.

The output of the sensor and computing unit controller 508 using the look-up table is used to adjust one or more parameters of the vehicle's systems. In some embodiments, one or more parameters of the vehicle's sensors 510 can be adjusted to operate at different levels (e.g., camera frame rate or LIDAR frequency). In some embodiments, one or more parameters (e.g., processor clock speed) of the vehicle's processors 512 are adjusted. In some embodiments, one or more parameters (e.g., voltage or current limit) of the vehicle's power supply 514 are adjusted.

Referring now to FIG. 6, illustrated is a flowchart of a process 600 for managing vehicle resources based on scenarios. In some embodiments, one or more of the steps described with respect to process 600 are performed (e.g., completely, partially, and/or the like) by the vehicle 502 and scenario recognition system 506 shown in FIG. 5. Additionally, or alternatively, in some embodiments one or more steps described with respect to process 600 are performed (e.g., completely, partially, and/or the like) by another device or group of devices separate from or including the vehicle 502 and scenario recognition system 506. For example, one or more of the operations described with respect to process 600 is performed (e.g., completely, partially, sequentially, non-sequentially, and/or the like) by the perception system 402, the planning system 404, and/or the control system 408 of the autonomous vehicle compute 400 of a vehicle (e.g., vehicle 102a, 102b, 102n described with reference to FIG. 1 or vehicle 200 described with reference to FIG. 2, or vehicle 502 described with reference to FIG. 5). Additionally, or alternatively, in some embodiments, one or more steps described with respect to the process 600 is performed (e.g., completely, partially, sequentially, non-sequentially, and/or the like) by another device or group of devices separate from or including the autonomous vehicle compute 400 and/or the example system 500.

At 602, information representative of the environment of the vehicle is obtained. The information can be obtained from one or more sensing devices (e.g., V2I device 110 described with reference to FIG. 1, cameras 202a, LiDAR sensors 202b, radar sensors 202c, and microphones 202d described with reference to FIG. 2, perception system 402 described with reference to FIG. 4, vehicle's sensors 510 attached to the vehicle described with reference to FIG. 5). The sensing devices can be attached to or integrated in the vehicle to identify agents present in an environment surrounding the vehicle and/or one or more operational parameters of the internal components of the vehicle. For example, the sensing devices can monitor parameters associated with the agents relative to the movement of the respective vehicle and parameters associated with the vehicle, to which they are attached. The parameters associated to the environment surrounding the vehicle can include, but are not limited to, parameters associated with movement of other vehicles (e.g., speed, direction, etc.) and/or other objects (e.g., pedestrians, light poles, etc.). The parameters associated with the vehicle can include, but are not limited to, parameters associated with vehicle's state, e.g., heading, driving speed, etc. Additionally, the parameters associated to the vehicle can include, but are not limited to, parameters associated with vehicle's operational status and indicators or potential malfunctions, e.g., tire inflation pressure, oil level, transmission fluid temperature, etc.

At 604, a current scenario of the environment of the vehicle is determined. In some embodiments, the current scenario is determined based on the information representative of the environment of the vehicle. In some embodiments, determining the current scenario includes providing the information representative of the environment of the vehicle to at least one machine learning model (e.g., the machine learning models 522, 524, 526 shown in FIG. 5). In such embodiments, the at least one machine learning model generates at least one output associated with the current scenario. The scenarios can be classified based on scenario types. The scenario types can include “high-traffic scenario,” “crowded pedestrian scenario,” “highway scenario”, “local road scenario”, “parking lot scenario” or other scenarios that can be encountered by the vehicle.

At 606, a level of computational resources appropriate for the determined current scenario is determined. In some embodiments, the level of computational resources is determined based on the determined current scenario. In some embodiments, determining the level of computational resources includes accessing an entry of a look-up table (e.g., the look-up table described with reference to FIG. 5). For example, the entry corresponds to the determined current scenario. In some embodiments, information about the current vehicle status is determined. For example, current vehicle status indicates whether the vehicle is stationary or moving. In such embodiments, the level of computational resources appropriate for the determined current scenario is determined based at least in part on the current vehicle status.

At 608, at least one parameter associated with at least one sensor is adjusted. In some embodiments, the adjustment is made based on the determined level of computational resources. In examples where a look-up table is used, the at least one parameter is adjusted based on information associated with an entry of the look-up table. In some embodiments, the at least one sensor comprises a LIDAR, and the at least one parameter comprises a rotational frequency of the LIDAR. In some embodiments, the at least one sensor comprises a camera, and the at least one parameter comprises a frame rate of the camera. In some embodiments, a voltage or current limit of the vehicle's power supply is adjusted based on the determined level of computational resources. In this way, the amount of power consumed by the vehicle is aligned to the scenario encountered by the vehicle. In some embodiments, a bandwidth of a communications network of the vehicle is adjusted based on the determined level of computational resources. For example, elements of the communications network enabling higher bandwidth are powered down to save on battery power. In some embodiments, a clock speed of the vehicle's processor or processors is adjusted based on the determined level of computational resources. For example, lowering the clock speed of a processor saves on battery power.

According to some non-limiting embodiments or examples, provided is vehicle, comprising: at least one computer-readable medium storing computer-executable instructions; at least one processor communicatively coupled to at least one sensor and configured to execute the computer executable instructions, the execution carrying out operations comprising: obtaining, from the at least one sensor, information representative of the environment of the vehicle; determining, based on the information representative of the environment of the vehicle, a current scenario of the environment of the vehicle; determining, based on the determined current scenario, a level of computational resources appropriate for the determined current scenario; and adjusting at least one parameter associated with the at least one sensor based on the determined level of computational resources.

According to some non-limiting embodiments or examples, provided is a method, comprising: obtaining, from the at least one sensor, information representative of the environment of the vehicle; determining, based on the information representative of the environment of the vehicle, a current scenario of the environment of the vehicle; determining, based on the determined current scenario, a level of computational resources appropriate for the determined current scenario; and adjusting at least one parameter associated with the at least one sensor based on the determined level of computational resources.

According to some non-limiting embodiments or examples, provided is at least one non-transitory computer-readable medium comprising one or more instructions that, when executed by at least one processor, cause the at least one processor to perform operations comprising obtaining, from the at least one sensor, information representative of the environment of the vehicle; determining, based on the information representative of the environment of the vehicle, a current scenario of the environment of the vehicle; determining, based on the determined current scenario, a level of computational resources appropriate for the determined current scenario; and adjusting at least one parameter associated with the at least one sensor based on the determined level of computational resources.

According to some non-limiting embodiments or examples, provided is an integrated circuit comprising: at least one hardware component configured for obtaining information representative of an environment of a vehicle; at least one hardware component comprising a scenario recognition system, the scenario recognition system configured for determining, based on the information representative of the environment of the vehicle, a current scenario of the environment of the vehicle; at least one hardware component comprising a look-up table, the look-up table usable to determine a level of computational resources appropriate for the determined current scenario; and at least one hardware component configured for adjusting at least one parameter associated with at least one sensor based on the determined level of computational resources.

Further non-limiting aspects or embodiments are set forth in the following numbered clauses:

Clause 1: A vehicle, comprising: at least one computer-readable medium storing computer-executable instructions; at least one processor communicatively coupled to at least one sensor and configured to execute the computer executable instructions, the execution carrying out operations comprising: obtaining, from the at least one sensor, information representative of the environment of the vehicle; determining, based on the information representative of the environment of the vehicle, a current scenario of the environment of the vehicle; determining, based on the determined current scenario, a level of computational resources appropriate for the determined current scenario; and adjusting at least one parameter associated with the at least one sensor based on the determined level of computational resources.

Clause 2: The vehicle of clause 1, wherein determining the current scenario of the environment of the vehicle comprises providing the information representative of the environment of the vehicle to at least one machine learning model, wherein providing the information causes the at least one machine learning model to generate at least one output associated with the current scenario.

Clause 3: The vehicle of any of the preceding clauses, wherein determining the level of computational resources appropriate for the determined current scenario comprises accessing an entry of a look-up table, the entry corresponding to the determined current scenario, and wherein the at least one parameter is adjusted based on information associated with the entry.

Clause 4: The vehicle of any of the preceding clauses, the operations comprising determining information about the current vehicle status, wherein the level of computational resources appropriate for the determined current scenario is determined based at least in part on the current vehicle status.

Clause 5: The vehicle of any of the preceding clauses, wherein the at least one sensor comprises a LIDAR sensor, and the at least one parameter comprises a rotational frequency of the LIDAR sensor.

Clause 6: The vehicle of any of the preceding clauses, wherein the at least one sensor comprises a camera, and the at least one parameter comprises a frame rate of the camera.

Clause 7: The vehicle of any of the preceding clauses comprising a power supply, the operations comprising adjusting a voltage of the power supply based on the level of computational resources appropriate for the determined current scenario.

Clause 8: The vehicle of any of the preceding clauses, comprising a communications network, the operations comprising adjusting a bandwidth of the communications network based on the level of computational resources appropriate for the determined current scenario.

Clause 9: The vehicle of any of the preceding clauses, the operations comprising adjusting a clock speed of the processor based on the level of computational resources appropriate for the determined current scenario.

Clause 10: A method comprising carrying out the operations specified in any of the preceding clauses.

Clause 11: A non-transitory computer-readable storage medium comprising at least one program for execution by one or more processors of a first device, the at least one program including instructions which, when executed by the one or more processors, cause the first device to perform the method of clause 10.

Clause 12: An integrated circuit comprising: at least one hardware component configured for obtaining information representative of an environment of a vehicle; at least one hardware component comprising a scenario recognition system, the scenario recognition system configured for determining, based on the information representative of the environment of the vehicle, a current scenario of the environment of the vehicle; at least one hardware component comprising a look-up table, the look-up table usable to determine a level of computational resources appropriate for the determined current scenario; and at least one hardware component configured for adjusting at least one parameter associated with at least one sensor based on the determined level of computational resources.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A vehicle, comprising:
at least one computer-readable medium storing computer-executable instructions;
at least one processor communicatively coupled to at least one sensor and configured to execute the computer executable instructions, the execution carrying out operations comprising:
obtaining, from the at least one sensor, information representative of the environment of the vehicle;
determining, based on the information representative of the environment of the vehicle, a current scenario of the environment of the vehicle;
determining, based on the current scenario, a level of computational resources appropriate for the current scenario; and
adjusting at least one parameter associated with the at least one sensor based on the level of computational resources.

2. The vehicle of claim 1, wherein determining the current scenario of the environment of the vehicle comprises providing the information representative of the environment of the vehicle to at least one machine learning model, wherein providing the information causes the at least one machine learning model to generate at least one output associated with the current scenario.

3. The vehicle of claim 1, wherein determining the level of computational resources appropriate for the current scenario comprises accessing an entry of a look-up table, the entry corresponding to the current scenario, and wherein the at least one parameter is adjusted based on information associated with the entry.

4. The vehicle of claim 1, the operations comprising determining information about the current vehicle status, wherein the level of computational resources appropriate for the current scenario is determined based at least in part on the current vehicle status.

5. The vehicle of claim 1, wherein the at least one sensor comprises a LIDAR sensor, and the at least one parameter comprises a rotational frequency of the LIDAR sensor.

6. The vehicle of claim 1, wherein the at least one sensor comprises a camera, and the at least one parameter comprises a frame rate of the camera.

7. The vehicle of claim 1, comprising a power supply, the operations comprising adjusting a voltage of the power supply based on the level of computational resources appropriate for the current scenario.

8. The vehicle of claim 1, comprising a communications network, the operations comprising adjusting a bandwidth of the communications network based on the level of computational resources appropriate for the current scenario.

9. The vehicle of claim 1, the operations comprising adjusting a clock speed of the processor based on the level of computational resources appropriate for the current scenario.

10. A method comprising:
obtaining, from at least one sensor, information representative of an environment of a vehicle;
determining, based on the information representative of the environment of the vehicle, a current scenario of the environment of the vehicle;
determining, based on the current scenario, a level of computational resources appropriate for the current scenario; and
adjusting at least one parameter associated with the at least one sensor based on the level of computational resources.

11. The method of claim 10, wherein determining the current scenario of the environment of the vehicle comprises providing the information representative of the environment of the vehicle to at least one machine learning model, wherein providing the information causes the at least one machine learning model to generate at least one output associated with the current scenario.

12. The method of claim 10, wherein determining the level of computational resources appropriate for the current scenario comprises accessing an entry of a look-up table, the entry corresponding to the current scenario, and wherein the at least one parameter is adjusted based on information associated with the entry.

13. The method of claim 10, comprising: determining information about the current vehicle status, wherein the level of computational resources appropriate for the current scenario is determined based at least in part on the current vehicle status.

14. The method of claim 10, comprising: adjusting a clock speed of the processor based on the level of computational resources appropriate for the current scenario.

15. A non-transitory computer-readable storage medium comprising at least one program for execution by one or more processors of a first device, the at least one program comprising instructions which, when executed by the one or more processors, cause the first device to perform operations comprising:
obtaining, from at least one sensor, information representative of an environment of a vehicle;
determining, based on the information representative of the environment of the vehicle, a current scenario of the environment of the vehicle;
determining, based on the current scenario, a level of computational resources appropriate for the current scenario; and
adjusting at least one parameter associated with the at least one sensor based on the level of computational resources.
